(19) United States
(12) Patent Application Publication
(10) Pub. No.: US 2007/0279483 A1
(43) Pub. Date: Dec. 6, 2007

(54) Blended Space For Aligning Video Streams

(76) Inventors: Ted W. Beers, Corvallis, OR (US); April Slayden Mitchell, Redwood City, CA (US); Mark E. Gorzynski, Corvallis, OR (US); Michael D. Derocher, Albany, OR (US); Thomas Moltoni, London (GB); Thomas Kleist, London (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/559,348

(22) Filed: Nov. 13, 2006

Related U.S. Application Data
(60) Provisional application No. 60/803,584, filed on May 31, 2006.
(60) Provisional application No. 60/803,588, filed on May 31, 2006.

(51) Int. Cl. H04N 7/14; H04L 12/56

(52) U.S. Cl. 348/14.08; 370/400; 348/E07.077

(57) ABSTRACT

A method is described for aligning video streams and positioning camera in a collaboration event to create a blended space. A local physical environment of one set of attendees is combined with respective apparent spaces of other sets of attendees that are transmitted from two or more remote environments. A geometrically consistent shared space is created that maintains natural collaboration cues of eye contact and directional awareness. The remote environments in the local physical environment are represented in a fashion that is geometrically consistent with the local physical environment. The local physical environment extends naturally and consistently with the way the remote environments may be similarly extended with their own blended spaces. Therefore, an apparent shared space that is sufficiently similar for all sets of attendees is presented in both the local and remote physical environments.

### CROSS-REFERENCE TO RELATED APPLICATIONS

This application claims the benefit of U.S. Provisional Application No. 60/803584, filed May 31, 2006 and herein incorporated by reference. This application also claims the benefit of U.S. Provisional Application No. 60/803,588, filed May 31, 2006 and herein incorporated by reference.

### BACKGROUND OF THE INVENTION

Collaboration events such as conventional internet-based video conferences have typically provided an unsatisfactory experience for participants. Attendees have been presented to each other in such participating environments in an unnatural fashion, such as a series of disassociated bodies on a display monitor. Confusingly, each attendee's environmental presentation has differed from the presentation of other attendee's environment with regard to the apparent positioning of the other attendees. Accordingly, interactions between attendees at different local environments have not appeared natural because of the lack of correspondences between what the interacting attendees see and what the observing attendees see.

Prior solutions allow for the creation of rendered and artificial spaces unlike any attendee's actual physical environment such as with first person video games. For instance, a gamer sitting in one's living room is able to represent oneself as a soldier in a battlefield context to other players in a multi-user game. Audio-only solutions exist to spatially distribute sound among environments by placing each environment's sound within a metaphorical auditory space.

The conventional video conferencing method for communication of the conference environment on a local monitor has been either a text-based or a 3D-representational space model description of a shared virtual room. Text-based solutions do not portray a sense of shared space. Indeed, from the verbal description, an attendee must interpret this shared space into a perceived visual representation. The 3D-representational space model goes overboard by projecting all users into one shared virtual room that does not represent the attendee's actual environmental space. Accordingly, this lack of actual physical awareness again requires some mental effort by attendees to identify with the proposed mapping of other attendees in the 3D space.

### SUMMARY OF THE INVENTION

A method is described for aligning video streams and positioning cameras in a collaboration event to create a blended space. A local physical environment of one set of attendees is combined with respective apparent spaces of other sets of attendees that are transmitted from two or more remote environments. A geometrically consistent shared space is created that maintains natural collaboration cues of eye contact and directional awareness. The remote environments in the local physical environment are represented in a fashion that is geometrically consistent with the local physical environment. The local physical environment extends naturally and consistently with the remote environments, that are similarly extended with their own blended spaces. Therefore, an apparent shared space that is sufficiently similar for all sets of attendees is presented in both the local and remote physical environments.

### BRIEF DESCRIPTION OF THE DRAWINGS

The invention is better understood with reference to the following drawings. The elements of the drawings are not necessarily to scale relative to one another. Rather, emphasis has instead been placed upon clearly illustrating the invention. Furthermore, like reference numerals designate corresponding similar parts through the several views.

FIG. 1A is a prior art schematic of a 2 point video conference connection that demonstrates the association of two environments in a virtual space.

FIG. 1B is a prior perspective view of the construction of the 2 point video conference connection of FIG. 1A which illustrates the feel of the two environments combined into the virtual space to recreate the feel of an actual meeting in a conference room.

FIG. 2 is a diagram of a 3-panel monitor arrangement used in several embodiments.

FIG. 3A is a schematic of a 3-point video conference connection with two users per site that demonstrates the association of more than two environments.

FIG. 3B is a similar schematic as FIG. 3A but with cameras zoomed to allow four users per site.

FIG. 4A is a schematic of a 4-point video conference connection with two users per site that demonstrates the association of an additional set of attendees beyond the 3-point video conference of FIG. 3A.

FIG. 4B is a diagram of the four attendees arranged around a conference table.

FIG. 4C is a simplified schematic of the arrangement in FIG. 4A.

FIG. 4D is a schematic of a 4-point video conference connection with four users per site similar to that shown in FIG. 4A.

FIG. 5 is an illustration of a video conference collaboration studio user interface that includes multiple sets of participants around a virtual conference table that allows an organizer for the meeting to create a blended space for the multiple sets of attendees.

FIG. 6 is an alternative illustration of the video conference collaboration studio of FIG. 5 that illustrates the creation of the blended space for one set of attendees' collaboration studio.

FIG. 7 is a tabular representation of how video streams are assigned and how camera angles are positioned for each set of attendees for a 2-seat 4-point blended space event to allow for attendees in four separate collaboration studios (with 2 attendees each) to meet while maintaining natural eye contact such as in FIG. 4A.

FIG. 8 is a tabular representation of how video streams are assigned and how camera angles are positioned for each set of attendees for a 4-seat 4-point blended space event to allow for attendees in four separate collaboration studios (with 4 attendees each) to meet while maintaining natural eye contact such as in FIG. 4D.

FIG. 9 is a tabular representation of how video streams are assigned and how camera angles are positioned for each set of attendees for an asymmetrical 2-seat 3-point blended space event such as in FIG. 3A. This configuration allows for attendees in three separate collaboration studios (with two attendees each) to meet while maintaining natural eye contact.

FIG. 10 is a tabular representation of how video streams are assigned and how camera angles are positioned for each set of attendees for an asymmetrical 4-seat 3-point blended space event such as in FIG. 3B. This configuration allows for attendees in three separate collaboration studios (with four attendees each) to meet while maintaining natural eye contact.

### DETAILED DESCRIPTION OF THE PREFERRED EMBODIMENT

The present disclosure describes not the creation of a metaphorical auditory space or an artificial 3D representational video space, both of which differ from the actual physical environment of the attendees. Rather, the present disclosure describes and claims what is referred to as a “blended space” for audio and video that extends the various attendees' actual physical environments with respective geometrically consistent apparent spaces that represent the other attendees' remote environments.

Accordingly, a method is described for aligning video streams and positioning cameras in a collaboration event to create this “blended space.” A “blended space” is defined such that is combines a local physical environment of one set of attendees with respective apparent spaces of other sets of attendees that are transmitted from two or more remote environments to create a geometrically consistent shared space for the collaboration event that maintains natural collaboration cues such as eye contact and directional gaze awareness. That is, the other attendee's remote environments are represented in the local physical environment of the local attendees in a fashion that is geometrically consistent with the local physical environment. By maintaining the geometric consistency, the resulting blended space extends the local physical environment naturally and consistently with the way the remote environments may be similarly extended with their own blended spaces. In this manner, each blended space for each set of attendees experiences natural collaboration cues such as sufficient eye contact and sufficient directional awareness of where other event attendees are looking at (e.g. gaze awareness). Each blended space thus provides dimensional consistency for all sets of attendees an apparent shared space that is sufficiently similar for all sets of attendees whether in local or remote locations.

A blended space for more than two meeting rooms is presented to allow for conference meetings in a multi-point meeting. The blended space should provide for approximate directional awareness and substantially direct eye contact with at least one person. Further, as additional sites are added or removed from a meeting, the blended space should allow for adding or removing persons while maintaining the correct geometry of the meeting space thereby maintaining a geometrically consistent environment. Additionally, the geometric environment can be allowed to grow or shrink in a dimensionally consistent manner the meeting as needed to accommodate the appropriate number of participants (such as two, three, or four available seats per each site as non-limiting examples). For instance, the blended space conference table may grow larger as people enter to accommodate more seats and objects across screens do not bend or break. Each site thus accommodates the same number of available seats (although some may be unoccupied or vacant) during each blended space event.

As used in the present specification and in the appended claims, the term “media” is defined to include text, video, sound, images, data, or any other information that may be transmitted over a computer network.

Additionally, as used in the present specification and in the appended claims, the term “node” is defined to include any system with means for displaying and/or transmitting media that is capable of communication with a remote system directly or through a network. Suitable node systems include, but are not limited to, a videoconferencing studio, a computer system, a notebook computer, a telephone, a cell phone, a personal digital assistant (PDA), or any combination of the previously mentioned or similar devices.

Similarly, as used in the present specification and in the appended claims, the term “event” is meant to be understood broadly as including any designated time and virtual meeting place providing systems a framework to exchange information. An event allows at least one node to transmit and receive media information. According to one exemplary embodiment, the event exists separate and distinct from all nodes participating in collaboration. Further, an event may exist while nodes are exchanging information and may also exist while no nodes are participating.

Further, as used in the present specification and in the appended claims, the term “topology” is meant to represent the logical relationship of the nodes in an event, including their connections with each other and their position within the event.

Moreover, as used in the present exemplary specification, the terms “subsystem” and “module” shall be used interchangeably to include any number of hardware, software, firmware components, or any combination thereof. As used in the present specification, the subsystems and modules may be a part of or hosted by one or more computing devices including, but in no way limited to, servers, personal computers, personal digital assistants, or any other processor containing apparatus such as codes, switches, and routers, to name a few. Various subsystems and modules may perform differing functions or roles and together remain a single unit, program, device, or system.

An “event management client” is an originator of an event management request. It may be a human driven event such as with a user interface or a machine request from another node, such as a concierge system running an event management application. Nodes may change their manner of participation in an event. Accordingly, the “event management client,” whether human or machine driven, allows for requesting to start and/or update events in the collaboration event.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

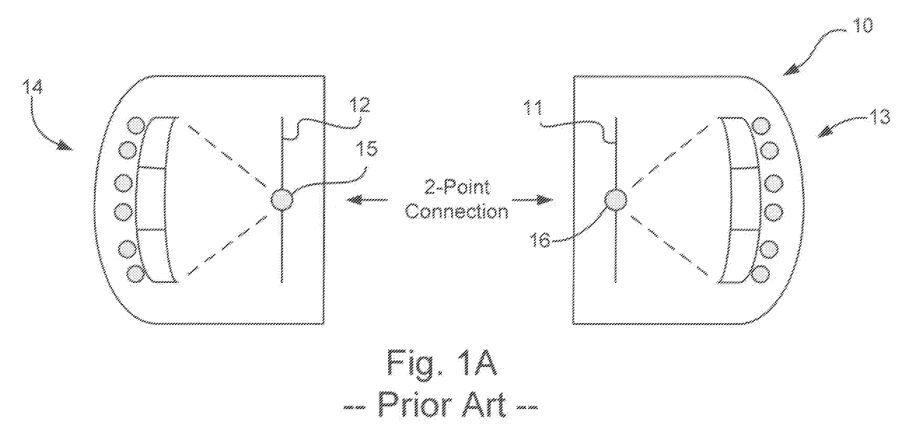

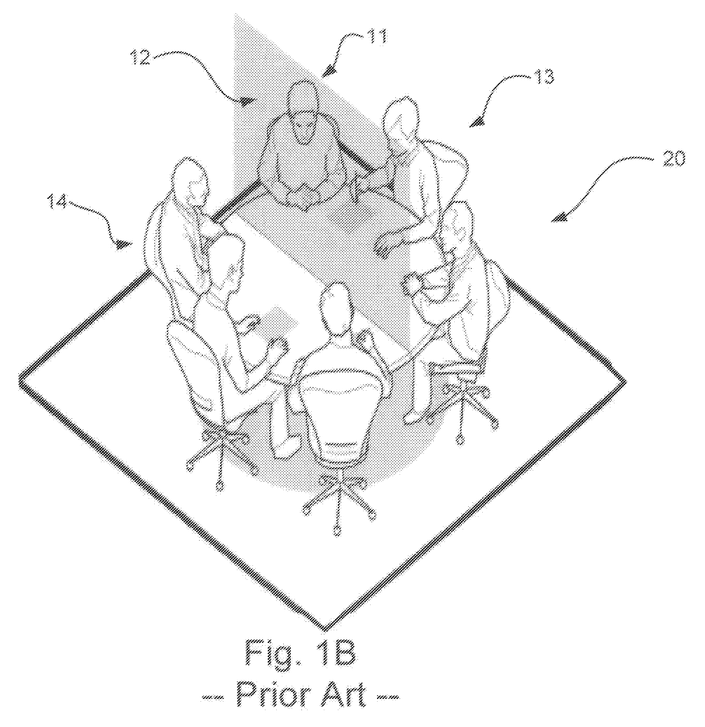

A look at a two environment system may be helpful in understanding the difficulty in extending into multi-point configurations. For example, FIG. 1A is a prior art schematic of a 2-point connection in a video conference 10 that demonstrates the association of two local environments in a virtual space to create the feel of an actual conference as shown in FIG. 1B. In this configuration, one connection is associated with first camera 15 providing a video and audio stream of a first group 14 of six attendees to a first display 11 that is viewable by a second group 13 of six attendees. The second group 13 is monitored by second camera 16 with a second connection that provides a video and audio stream to second display 12 that is viewed by the first group 14. The local environment of each group are made physically consistent such that when first group 14 views second group 13 on second display 12 the shared environment appears consistent such as illustrated in FIG. 1B to provide the feel of a shared environment virtual space 20.

FIG. 1B is a prior art perspective view of the construction of the 2-point connection video conference connection of FIG. 1A (only three attendees each are shown in brevity) which illustrates the feel of the two environments when combined into the shared environment virtual space 20 to recreate the feel of an actual meeting in a conference room. In this environment, the first group 14 is seated at their conference table and is able to observe second group 13 seated at their conference table through second display 12. Likewise, second group 13 is able to view first group 14 on first display 11. If the conference tables are positioned to the displays close enough and the cameras are able to project life size images of the various groups on the respective displays, the illusion of an actual meeting is achieved. However, when expanding beyond the 2-point connection to have multiple conference sites, it becomes difficult to determine how participants should be seated and presented around a conference table. For instance, who should be seated on the left and who should be seated on the right of the local attendees?

The present system solves this dilemma by having a system that includes a management subsystem configured to dynamically configure the topology of a virtual collaborative event to create a blended space. The management subsystem is configured to receive and process requests originating from at least one event management client, such as with a user interface or server request. The configuration of the collaborative event topology includes the determination of various media stream connections among multiple nodes based on at least one policy for maintaining a geometrically consistent space. This space preserves eye contact and directional awareness. The media stream connections establish and maintain actual relationships among said nodes.

In one exemplary embodiment, the system is made up of a communication network and a plurality of nodes communicatively coupled to the communication network. A management subsystem is communicatively coupled to the network and interfaces to an event management client. The management subsystem is configured to dynamically manage the topology of a blended space collaborative event based on the event management client.

According to one exemplary embodiment, the virtual relationships established between the various nodes of the present exemplary system can simulate spatial relationships between attendees and promote meaningful interaction. Particularly, according to one exemplary embodiment, the perceived topology and issued directives may correspond to certain virtual relationships being envisioned as seats around an imaginary conference table, where video and audio are perceived to come from the left, right, or directly in front of the attendee. According to one exemplary embodiment, the virtual relationships are maintained throughout an event, giving an event a sense of realism and eliminating distractions.

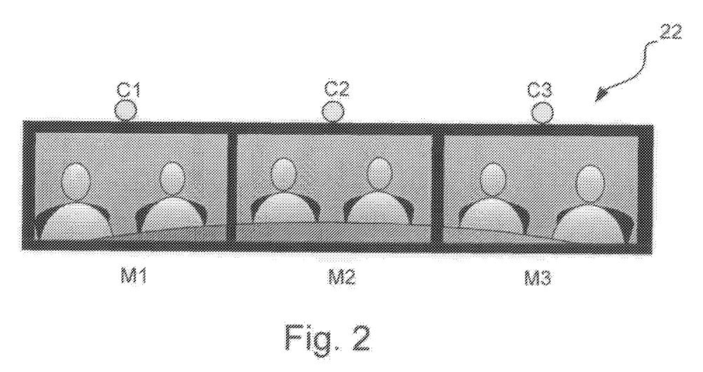

FIG. 2 illustrates an exemplary three panel display 22 used in embodiments of conference rooms at different sites. Each of the display panels or screens M1-M3 are able to present separate video streams to the participants as well as audio streams. Each of the display panels M1-M3 have an associated video camera C1-C3 that can have the geometric angle and zoom factor adjusted to provide both direction and varying size of the image captured. For instance, the camera angle can be adjusted to best fit where the participants are seated along the local conference table. The zoom can be adjusted to highlight a single, two, three, four, or more attendees into the video stream. In addition, the display panels M1-M3 or portions of a larger display such as a video wall can be positioned on a wall or off the floor at various angles to help present to the local attendees a better perspective and eye contact rather than just being in a straight layout. Thus, each display panel and video camera pair acts as a separate node that can be independently configured.

According to one exemplary embodiment, the consideration of virtual relationships between nodes and their corresponding video streams allows an attendee to speak with remote attendees as if they were looking through a virtual window. Once type of virtual relationship may include, for example, the association of a video input stream from an identified node with a corresponding display, camera, and video output stream to allow natural eye contact between attendees at the two nodes. If video from a first node is displayed on the left-most display of a second node, the left-most camera of the second node may be configured to capture the video stream sent back to the first node. Consequently, when an attendee turns to view the left display, his expressions and comments are transmitted as if he were speaking directly to the attendee displayed on his screen. The connection of video streams to appropriate displays maintains natural eye contact and facilities natural communication among attendees. Additionally, this exemplary configuration allows the participants to know when other participants are distracted or are shifting their attention from one participant to another.

In conjunction with the video arrangement described above, audio streams may also be linked between attendees based on a virtual relationship between the nodes. Specifically, according to one exemplary embodiment, audio recorded from a specific node may be reproduced at the recipient node with the same orientation as the display showing the attendee transmitting the audio stream. Each attendee's voice received then corresponds spatially with the video image of that attendee, enhancing the perceived relationship between the attendees.

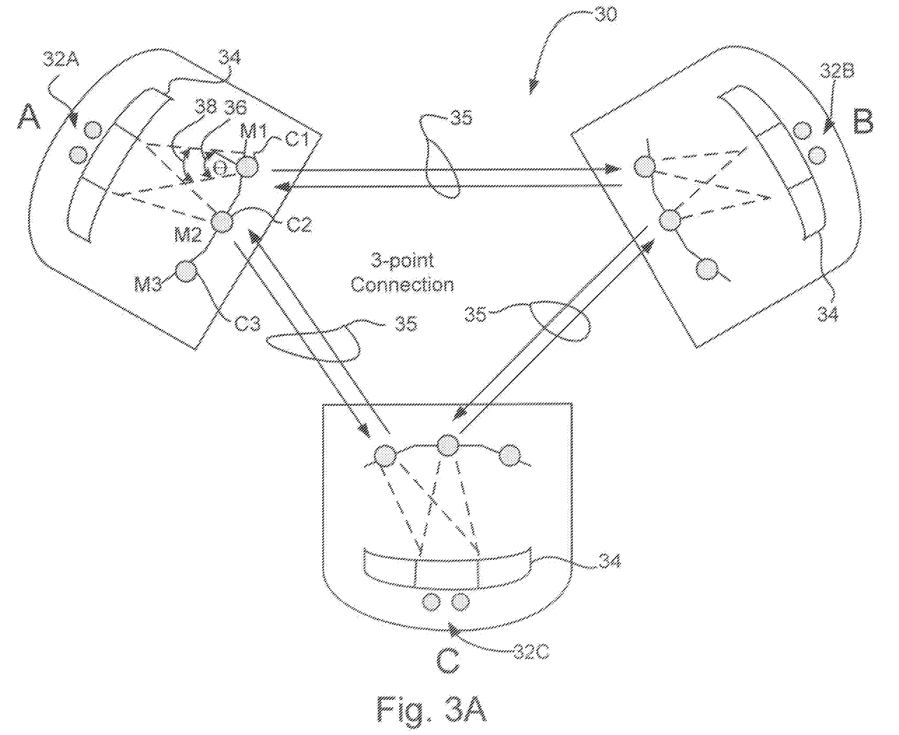

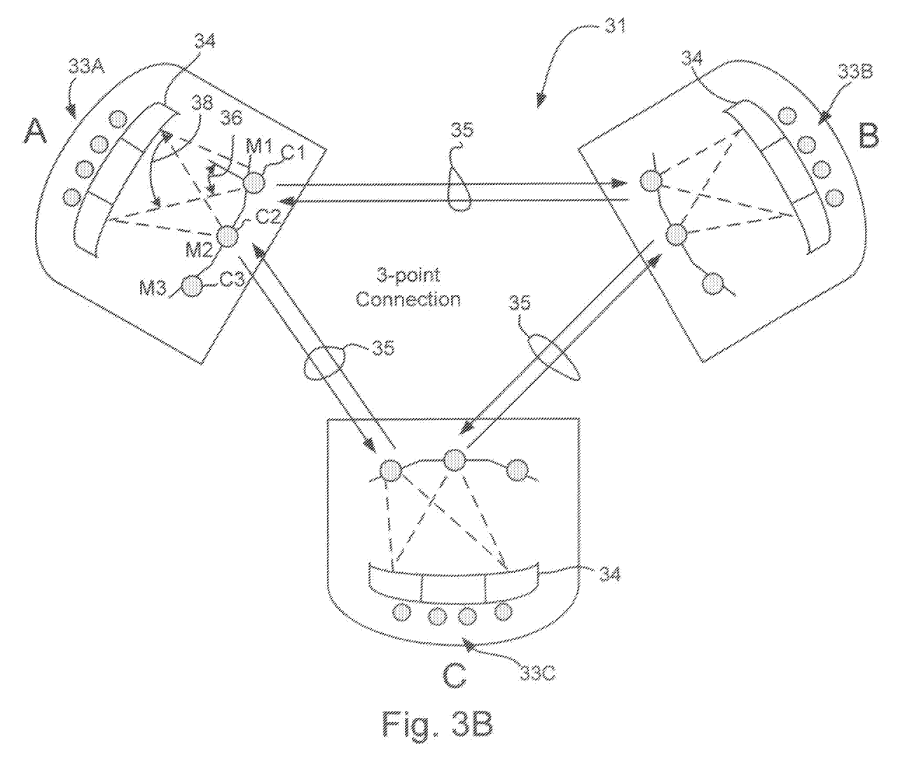

FIG. 3A is a schematic of a 3-point video conference connection that demonstrates the association of more than two environments. To create a blended space and thus create a geometrically and thus dimensionally consistent meeting of attendees (32A-32C) around a table within a conference room, the meeting participants are organized around a rounded shaped conference table 34. Because there are two attendees per site location, it is not possible to create the feel of the two environment virtual space as shown in FIG. 1B without adding additional displays and cameras. However, to maintain the eye contact and gaze awareness, it is important to properly configure the video streams from each camera to the appropriate display. In addition, each camera is associated with a respective display and has associated with it a geometric angle 36 and zoom factor 38 to direct the camera's view and envelopment of the appropriate attendees.

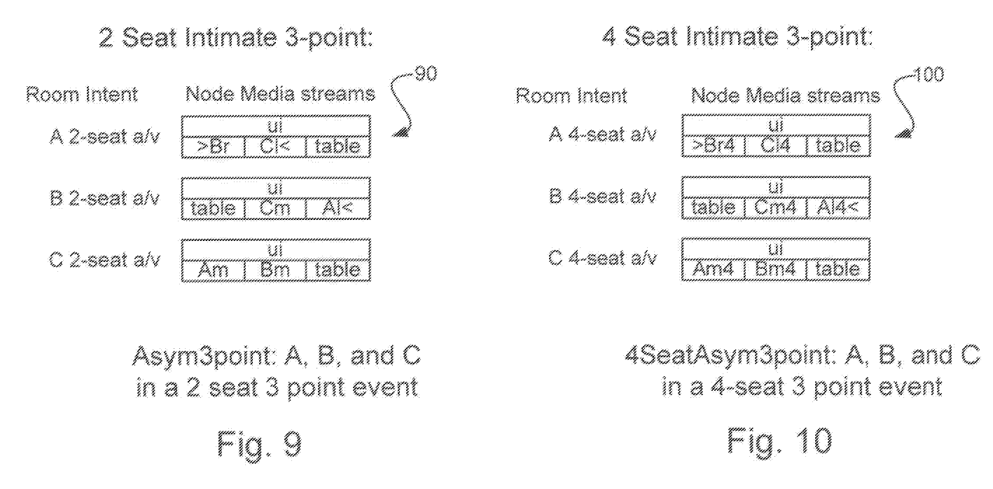

FIGS. 3A and 9 are exemplary configurations 30 and 90 for this environment when there are two attendees per physical location seated in the middle of the conference table. Thus, FIG. 9 is a tabular representation of how video streams are assigned and how camera angles are positioned for each set of attendees for an asymmetrical 2-seat 3-point blended space event. This configuration allows for attendees in three separate collaboration studios (with two attendees (32A-32C) each) to meet while maintaining natural eye contact. Given that there are three screens M1-M3 available for each location, one of the screens in each location is filled with a table image and appropriate matching background to keep the illusion of a complete conference table present but with no attendees in those locations. For the A location, the left screen M1 contains the B attendees imaged with the camera associated with the B location's right screen M3 and directed at the B attendees having an angle 36 that is directed form their right side. The middle screen M2 in the A location contains the C attendees with the camera associated with the C location's left screen M1 directed at the C attendees having an angle 36 that is directed from their left side. Both of the B and C cameras' zooms 38 are be set to display the two attendees with as left size as possible in the respective screen in A's location to simulate a real presence feel. Also, high definition screens can be used to achieve clarity via high resolution imaging. By angling the cameras appropriately, the gaze awareness is maintained. The right screen M3 in the A location is imaged with the empty table.

For the B location, its left screen M1 is imaged with the empty table. The middle screen M2 is imaged with the camera associated with the C location's middle screen M2 and it is directed at C's attendees seated at the center of the table. The right screen M3 in the B location is imaged with the camera associated with the A location's left screen M1 and it is directed to the A attendee's seated at the center of their conference table 34 thus having an angle 36 that is directed from their left side. Both of the A and C cameras' zooms 38 are be set to display the two attendees with as life size as possible in the respective screen in B's location to simulate a real presence feel.

For the C location, the left screen M1 contains the A attendees imaged with the camera associated with the A location's middle screen M2 and directed at the A attendees having an angle 36 that is directed directly at them. The middle screen M2 in the C location contains the B attendees with the camera associated with the B location's middle screen M2 directed at the B attendees having an angle 36 that is directed directly at them. Both of the A and B cameras' zooms 38 are be set to display the two attendees with as life size as possible in the respective screen in C's location to simulate a real presence feel. The right screen M3 in the C location is imaged with the empty table.

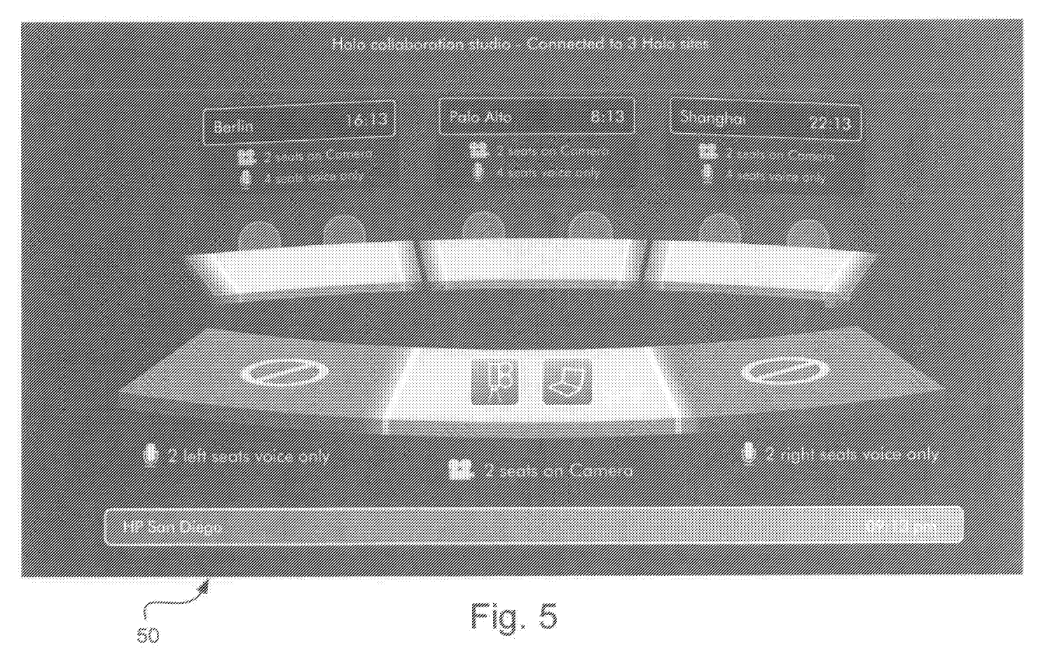

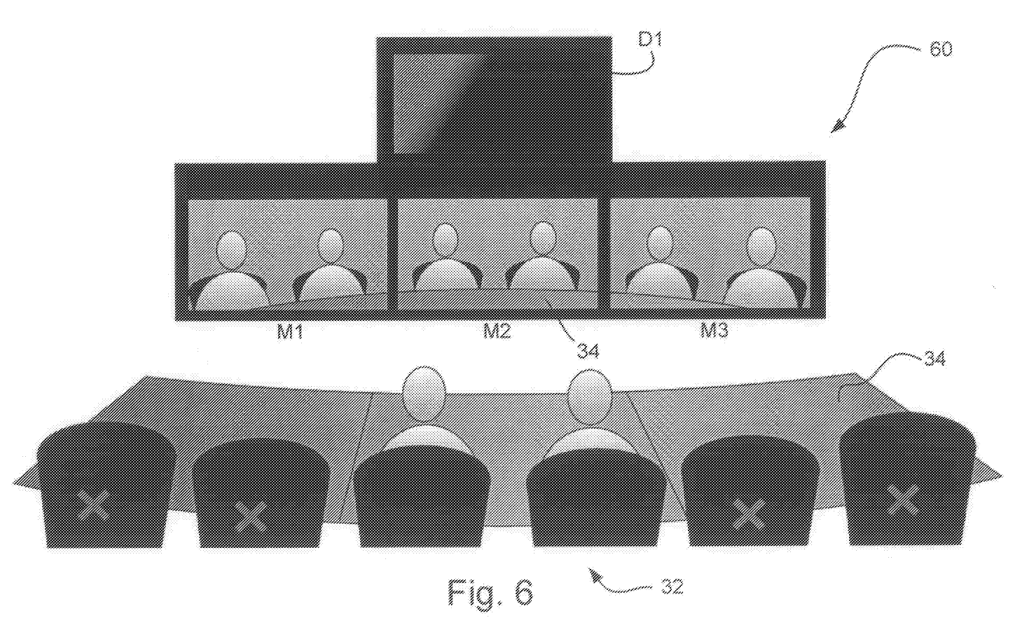

For all locations there can be one or more additional monitors (such as D1, FIG. 6) located above, below, right, or left of the three screens M1-M3, or elsewhere, that provide additional information such as shared documents, videos, pictures, graphics, or a user interface for setting up the room configuration. Of course, as mentioned, the three screens may be part of a video wall, in which case, the three screens represent locations on the video wall.

FIG. 3B and FIG. 10 are an exemplary configuration 31 and 100 for this environment when there are four attendees per physical location seated appropriately at the center the conference table. Thus, FIG. 10 is a tabular representation of how video streams are assigned and how camera angles are positioned for each set of attendees for an asymmetrical 4-seat 3-point blended space event. This configuration allows for attendees in three separate collaboration studios (with four attendees (33A-33C)each) to meet while maintaining natural eye contact. The zoom factors 38 of the cameras are adjusted to allow four attendees to be shown per display. The camera angles 36 and display feed configurations are similarly configured as described above for FIG. 9. By pre-configuring the appropriate camera-display feeds and setting the camera's angles 36 and zoom factors 38, natural eye contact and gaze awareness is maintained as close as possible to a real physical meeting. Further, the pre-configuration allows the proper blended space to be set up and maintained throughout the meeting without requiring the users to manually configure the camera angles and displays, thus allowing for a more natural communication with remote users than prior art configurations. In addition, the video and audio feeds can be fed directly without having to do additional signal processing, thus allowing for a low latency and thus a natural conversation flow without pauses required for transmission delay.

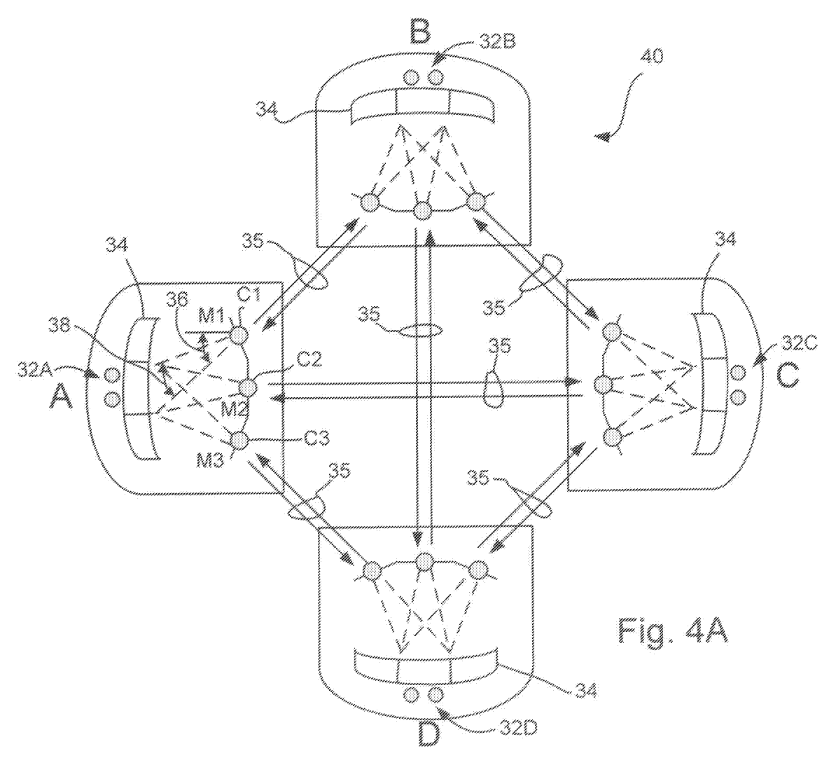

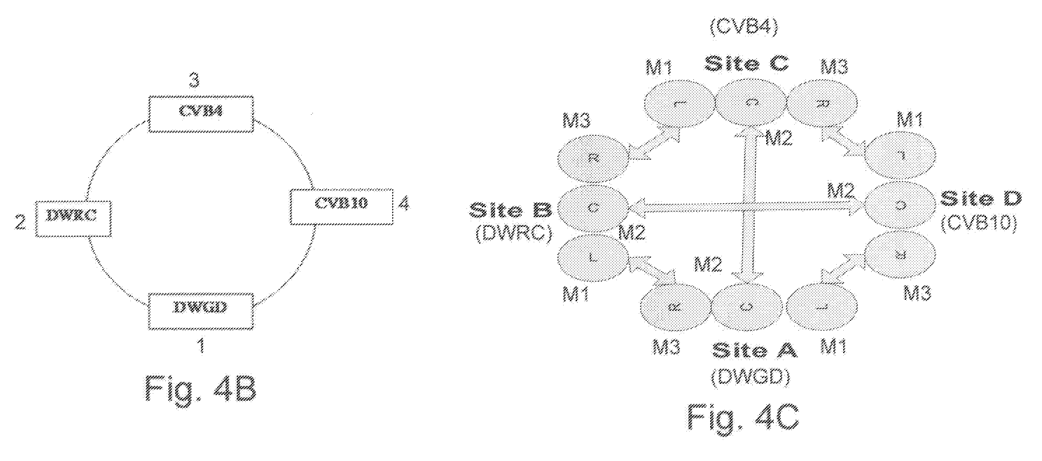

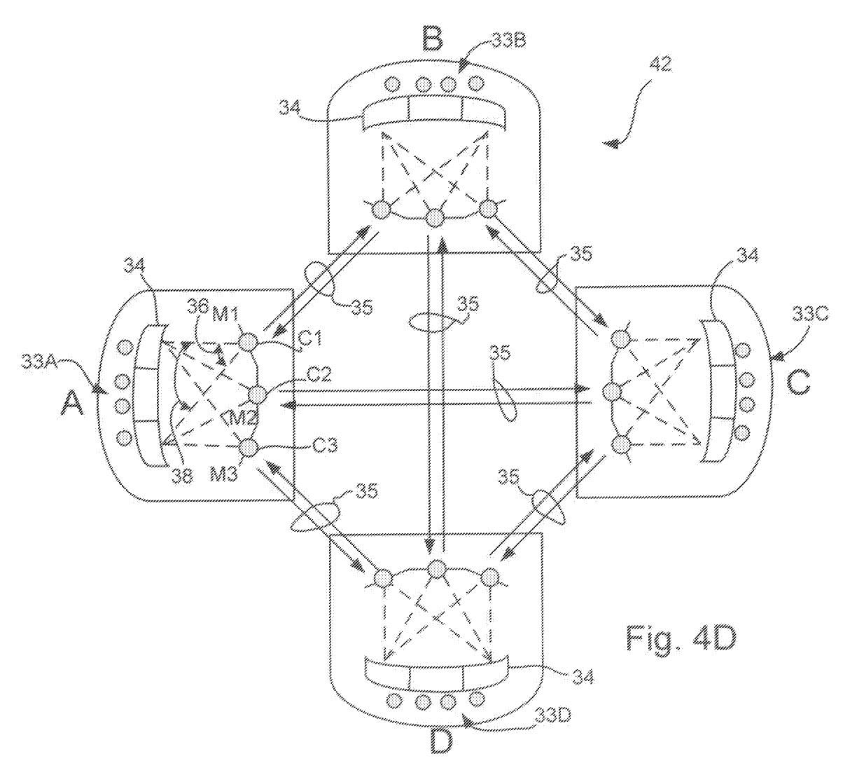

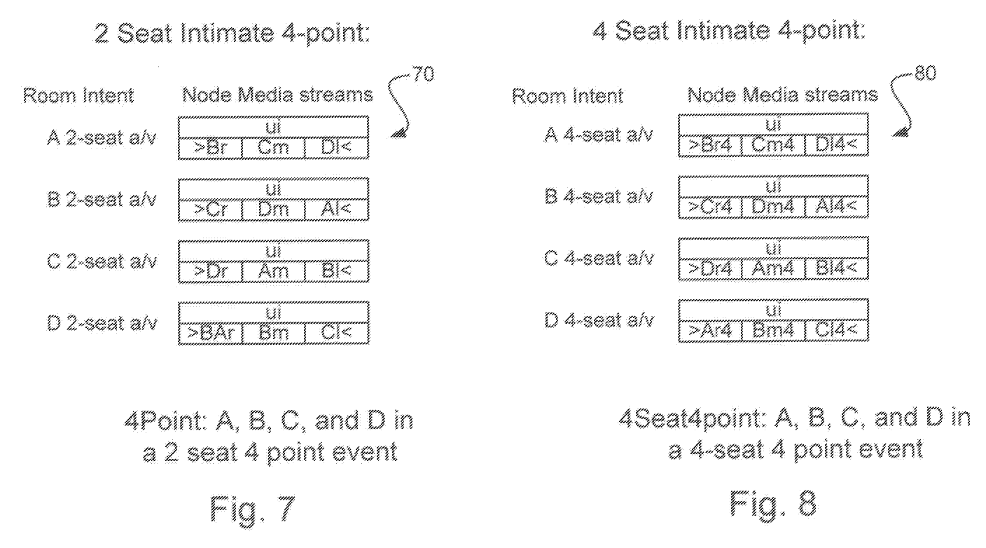

FIG. 4A is a schematic of a 4-point video conference connection 40 that demonstrates the association of an additional set of attendees beyond the 3-point video conference of FIG. 3A while maintaining the geometrically consistent meeting of the attendees around a table within a conference room. FIG. 7 is a tabular representation 70 of how video streams are assigned and how camera angles are positioned for each set of attendees for a 2-seat 4-point blended space event to allow for attendees in four separate collaboration studios (with 2 attendees (32A-32D)each) to meet while maintaining natural eye contact.

FIG. 4D is a schematic of a 4-point video conference connection 40 with the cameras zoomed to four attendees and FIG. 8 is a tabular representation 80 of how video streams are assigned and how camera angles are positioned for each set of attendees for a 4-seat 4-point blended space event. This configuration allows for attendees in four separate collaboration studios (with four attendees 33A-33D)each) to meet while maintaining natural eye contact.

When creating a geometrically consistent environmental for the participants, there needs to be some way to aesthetically control the visual and audio enthronements so that it appears natural to the participants. Collaboration events appear very natural when attendees' everyday expectation regarding their visual relationship to other attendees are preserved. Accordingly, the blended space of the present disclosure is configured to be geometrically consistent to facilitate each natural eye contact and third-party awareness of interactions among other attendees.

In such a geometrically consistent blended space, the camera angles 36 are determined based on the assignment of a set of attendees into a location in the virtual space to allow for sufficient direct eye contact. Further, if an assignment is left open, the video stream is substituted with an acceptable image to maintain the illusion of a geometrically consistent environment. For example, an empty table image (but geometrically and thus dimensionally consistent) is one extreme of this illusion when there may be multiple screens but not enough participating sites with sets of attendees.

A blended space therefore combines a local physical environment (a set of attendee's actual local collaboration room) with apparent spaces transmitted from one or more remote environments (the other set of attendee's local collaboration rooms) that are represented locally in a fashion that is geometrically consistent with the local environment. This resulting blended space extends the local environment naturally and consistently with the way the remote environments may be similarly extended. That is, each local collaboration room has its own local environment that has a blended space created with the other remote environments. However, each blended space must be created to allow the others to maintain geometric consistency. In this manner, each blended space experiences natural collaboration cues such as sufficient eye contact and thus sufficient awareness of where other event attendees are looking (gaze awareness). Accordingly, an apparent shared space is created that is sufficiently similar for all attendees local and remote.

The blended space is typically designed to correspond to a natural real-world space, such as a meeting room with a round conference table 34 arranged with meeting attendees around it. A particular blended space for each local collaboration studio is determined based upon the geometrical positioning and zoom factor of the video camera(s) and display(s) within each physical local environment that is participating in a collaboration event. Determination of the blended space considers the relative positioning of the cameras and displays to assign where the output of each camera will be displayed. Therefore, for a given combination of environment types (e.g., three cameras, each center-mounted above three side-by-side displays) and collaboration event types (e.g., three environments of the same type each displaying four attendees), the blended space may be represented by meta-data sufficient for each environment to be configured for participating in the event. Such meta-data may be determined by formula or by other means. One assignment scheme uses a modulo number of positions. For example, the formula=MOD(virtual_position−1,N) where N=4 for four positions will generate the results shown in Table 1.

TABLE 1

| Virtual Position | Local 1 | Local 2 | Local 3 | Local 4 |
|---|---|---|---|---|
| 1 | 0 | 3 | 2 | 1 |
| 2 | 1 | 0 | 3 | 2 |
| 3 | 2 | 1 | 0 | 3 |
| 4 | 3 | 2 | 1 | 0 |

A collaboration event may change, for example when another set of attendees from another remote environment joins the collaboration event. Under these circumstances, the blended space may be re-calculated and the camera and display assignments updated to reflect a different blended space, which typically will be defined substantially similar to the blended space it replaces.

When the nature of the collaboration event allows or requires, non-attendee video stream(s) may be assigned to the displays of the environment(s) to enhance the appearance of the blended space. For example, an image of a portion of a meeting table may complete the blended space when there is a lack of a set of attendees to complete the desired collaboration event.

One typical generalized multi-point blended space may include a videoconference system with one or more acquisition devices such as cameras, microphones, scanners, speakers and one or more reproduction devices such as displays, speakers, printers. In addition, the videoconference system will need one or more data paths connecting these devices sufficient to enable acquired data with one or more connection. Given a collaboration studio environment with three monitors plus the local table, consider a video conference with four connects between a first company COA with two sites CVB4 and CVB10 and a second company COB and its two sites DWRC and DWGD. One can arbitrarily assign each site a position in the blended space around a round conference table such as in Table 2 and illustrated in FIG. 4B.

TABLE 2

| Site | Position |
|---|---|
| DWGD | 1 |
| DWRC | 2 |
| CVB4 | 3 |
| CVB10 | 4 |

For audio and video, a model is made for which stream carries the active camera and audio for each position. At any site, any table position is activated for a video stream but has to be sure to mix in the audio to that video stream. Additional flexibility in the configuration allows for rather than having four physical sites, just 3 physical sites with one site activating 2 cameras to achieve 4 streams. Thus, each seat around the round conference table represents a monitor with an associated camera. Accordingly, each camera at a site is treated as a separate position around the table. A physical site with just two active camera when there are three available may have either a dead (inactive) display or a display with an image of just the conference table.

Assuming we number the displays as in FIG. 2 from left to right as viewed from each local site's physical table; where M1 is the left most monitor or display, M2 the center, and M3 the right most monitor, one can then assign streams within the blended space according to position using the above modulo formula to arrive at the arrangement in Table 3.

TABLE 3

| | Left (L) | Center (C) | Right (R) |
|---|---|---|---|
| Site | M1 | M2 | M3 |
| A) DWGD | CVB10 | CVB4 | DWRC |
| B) DWRC | DWGD | CVB10 | CVB4 |
| C) CVB4 | DWRC | DWGD | CVB10 |
| D) CVB10 | CVB4 | DWRC | DWGD |

This mapping of the video streams thus create the 4-point camera mapping as in FIG. 4C. The arrows in the figure below show correspondence between cameras and displays between sites. All cameras are positioned to view two participants seated at center of table.

To ensure that the blended space is configured properly, a user interface must be able to represent this blended space visually so that the meeting participants easily comprehend it.

FIG. 5 is an illustration 50 of a video conference collaboration studio presented in an event management client (EMC) such as with a user interface (UI) that includes multiple sets of participants around a virtual conference table which allows an organizer for the meeting to create a blended space for the multiple sets of attendees.

FIG. 6 is an alternative illustration 60 of the video conference collaboration studio of FIG. 5 that illustrates the creation of the blended space for one set of attendee's 32 local collaboration studio.

One method of allowing additional attendees to join the blended space is to provide one or more event management clients, such as with a user interface (UI) (see FIGS. 5 and 6) that represents the blended space with the organization of the meeting. The orientation of the UI method starts with a graphic representation of each location's tabletop shape on a separate interface display (the UI monitor, D1-FIG. 6), arranged according to the placement that users will appear on the displays on the walls in the studios. This is a local view, with their local table taking the front and center location. As collaboration studios are invited, their information appears above the tabletop that they will occupy relative to the location viewing the interface.

The UI provides feedback in the form of a connection sequence animation that provides confirmation to the meeting organizer that the invites have been sent, and that connections are occurring with the studios before people actually show up on display and audio.

The UI allows for a spatial orientation map for users to easily grasp. Overall the 3D tabletop icons represent the meeting space as occupied by the number of table sections in the map. The orientation is from the observers point of view, with the one ‘front’ table representing the ‘here’ for each observer location, and 1-3 tabletops across from it representing the relative ‘there’ locations assigned to or joined in the meeting.

The UI allows for invitation usability with the ‘there’ tables mapped to their respective people displays, setting up invitations clearly communicates to the users in advance which displays their meeting attendees will occupy. The ordering can be a default sequence, or customized during invitation to rearrange attendees to match the appropriate table locations for the meeting.

The UI permits people locations ‘on camera’ ad ‘off camera’ to be distinguished graphically. For example, iconic seating locations, matching the number of seats in each respective studio, are highlighted or dimmed to indicate which seat locations will be sent to the other studio people displays. This graphical distinguishing helps users understand if there may be additional users at locations that they can hear, but not see on the display.

One advantage of this 3D icon interface includes spatial orientation for users of the entire blended space event relative to their individual location. This spatial orientation includes who is at the meeting table and where is each seating location. Invitation usability is enhanced by placing locations at their seating locations by purposeful placement of 1 or more locations in the event space. The location names and local times are tied to people displays. Further, people on the display can be visually mapped to their unique physical location by the relative position of text and table section on the table icon graphic. Accordingly, people locations ‘on camera’ and ‘off camera’ are distinguished graphically.

While the present invention has been particularly shown and described with reference to the foregoing preferred and alternative embodiments, those skilled in the art will understand that many variations may be made therein without departing from the spirit and scope of the invention as defined in the following claims. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element of the equivalent thereof, such claims should be understood to include incorporation of one or more such elements, neither requiring nor excluding two or more such elements.

What is claimed is:

1. A system comprising:
a management subsystem configured to dynamically configure the topology of a virtual collaborative event to create a blended space, said management subsystem being further configured to receive and process requests originating from at least one event management client, wherein the configuration of said topology includes the determination of media stream connections among multiple nodes based on at least one policy for maintaining a geometrically consistent space preserving eye contact and direction awareness, wherein said media stream connections establish and maintain actual relationships among said nodes.

2. A system comprising:
a communication network;
a plurality of nodes communicatively coupled to said communication network;
a management subsystem communicatively coupled to said network and interfacing to an event management client; and
wherein said management subsystem is configured to dynamically manage the topology of a blended space collaborative event based on said event management client.

3. A method for aligning video streams and positioning cameras in a collaboration event to create a blended space, comprising:
combining a local physical environment of one set of attendees with respective apparent spaces of other sets of attendees that are transmitted from two or more remote environments;
creating a geometrically consistent shared space that maintains natural collaboration cues of eye contact and directional awareness;
representing the remote environments in the local physical environment in a fashion that is geometrically consistent with the local physical environment; and
extending the local physical environment naturally and consistently with the way the remote environments may be similarly extended with their own blended spaces, wherein an apparent shared space that is sufficiently similar for all sets of attendees is presented in the local and remote physical environments.

4. The method of claim 3, further comprising:
presenting a portion of a conference table that is geometrically consistent with an actual conference table in the local environment.

5. The method of claim 3, wherein each local environment has three displays mounted side-by-side in a left-center-right configuration and three cameras, each respectively center mounted above one of the three displays.

6. The method of claim 5, further comprising:
associating each camera in all environments with a respective display in another environment; and
configuring video streams for each camera to an appropriate display.

7. The method of claim 5, further comprising: assigning a geometric angle and zoom factor to direct a respective view and envelopment of appropriate attendees for each camera.

8. The method of claim 7, wherein the zooms of the camera are set to display two attendees substantially life size.

9. The method of claim 7, wherein the camera angles are determined based on the assignment of attendees into a location of the virtual space to allow for substantially direct eye contact.

10. The method of claim 3 wherein the steps of associating each camera and configuring video streams are done before the meeting starts and are maintained throughout the meeting.

11. The method of claim 3 further comprising aesthetically controlling the visual and audio environment to make it appear natural to the attendees by maintaining eye contact, and third party awareness of interactions among attendees.

12. The method of claim 3 wherein the step of configuring video streams includes configuring non-attendee video streams that are assigned to displays of the local environments to further enhance the appearance of the blended space.

13. The method of claim 12, wherein the non-attendee video streams include an image of a blank conference table if no attendees are present to maintain the illusion of a geometric consistent environment.

14. The method of claim 3 wherein the blended space combines a set of attendees in a local environment with apparent spaces transmitted from remote locations that are represented locally in the local environment that is geometrically consistent with the local room environment.

15. The method of claim 14, wherein each remote environment has its respective remote locations presented geometrically consistent in the blended space.

16. The method of claim 14, wherein each remote environment has its own local environment that has a blended space consistent with the other remote environments.

17. The method of claim 3 wherein the blended space is represented by meta data sufficient for each local environment to be configured for participation in the collaboration event.

18. The method of claim 17 wherein the meta data is determined by a formula.

19. The method of claim 18, wherein the assignment screen for the video streams uses a modulo number of positions.

20. The method of claim 19 wherein the formula is MOD(virtual position−1,N) where N is the number of sets of attendees and virtual position represents a location around a virtual conference table.

21. The method of claim 17, wherein the meta data is recalculated when another set of attendees from another remote location joins the collaboration event.

22. The method of claim 21, wherein a set of camera angles and set of display assignments are updated when the meta data is recalculated to create a new blended space.

23. The method of claim 3 wherein the configuration of the collaboration event is provided by an event management client (EMC) that represents the blended space with the organization of the meeting with animated sequences of connecting virtual tables.

24. The method of claim 23 wherein the EMC displays information above the virtual table that a remote environment will occupy relative to the local environment viewing the EMC.

25. The method of claim 23 wherein the virtual tables are presented in tangible three-dimensional format that is oriented to each observer and wherein the virtual table shapes conform to a shaped convention that permits their being illustrated as joined in 3D spaces.

26. The method of claim 23 wherein the EMC presents a front table representing the local location and at least one virtual table across from the front table for each of the remote locations.
